(19) United States
(12) Patent Application Publication
(10) Pub. No.: US 2015/0221342 A1
(43) Pub. Date: Aug. 6, 2015

(54) Method of Recording a Media Stream with Interactive Elements

(71) Applicant: Jong Wan KIM, Roswell, GA (US)

(72) Inventor: Jong Wan KIM, Roswell, GA (US)

(21) Appl. No.: 14/254,618

(22) Filed: Apr. 16, 2014

Related U.S. Application Data
(60) Provisional application No. 61/934,952, filed on Feb. 3, 2014.

(51) Int. Cl. G11B 27/036; H04N 5/77; G06F 3/0484; G06F 3/0488; G06F 3/0482; G06F 3/0481; G11B 20/10; H04N 5/272

(52) U.S. Cl. CPC G11B 27/036; G11B 20/10527; H04N 5/77; H04N 5/272; G06F 3/0488; G06F 3/0482; G06F 3/04817; G06F 3/04842

(57) ABSTRACT

A method of recording a media stream with interactive elements provides a process that enhances the capture of a media stream with overlaid media elements. The method utilizes a user viewable screen to displaying the interactive media elements on top of a media stream. The interactive media elements are able to receive user inputs that control or modify information displayed and recorded with the media stream. The interactive media elements are provided as controlling elements and recorded elements. Both elements can control the information displayed as part of the captured media stream. The method is well suited for implementation with touch screen devices as well as devices with limited input means.

The current application claims a priority to the U.S. Provisional Patent application Ser. No. 61/934,952 filed on Feb. 3, 2014.

### FIELD OF THE INVENTION

The present invention relates generally an interactive video recording method. More specifically, the present invention is an interactive video recording method to insert information in real-time while recording the events.

### BACKGROUND OF THE INVENTION

Media recording devices allow a user to capture audio and visual data associated with a primary media stream. Existing media recording devices rarely provide features that enhance a media stream recording. Even fewer offer features allowing a user to enhance the media stream recording during the recording process. Typically, a user is limited in their options for enhancing their media recordings to either utilizing post production software or non interactive media elements. Post production software allows a user to fully manipulate their recording to add, remove, and modify aspects to their media stream recording. Unfortunately post production software is expensive to own and usually has a sharp learning curve. Non interactive media elements allow a user to insert graphical elements into their media stream recording such as a border or an overlay. While these elements may be effective on some devices, they may be difficult to use or implement on devices with limited input means.

Therefore it is object of the present invention to provide interactive media elements that are recordable to a media stream. The interactive media elements are able to receive user inputs that control or modify information displayed and recorded of the interactive media elements. In order to accomplish this, the present invention is provided with a method of recording media stream with interactive elements. The interactive elements are provided as controlling elements and recorded elements. Both elements can control the information displayed as part of the captured media stream. The present invention is well suited for implementation on touch screen devices as well as devices with limited input means.

### BRIEF DESCRIPTIONS OF THE DRAWINGS

FIG. 1 is an illustration displaying the combined media stream implemented through a touch screen device as per the current embodiment of the present invention.

FIG. 2 is an illustration displaying the recordable media elements in the recordable combined media stream as per the current embodiment of the present invention.

FIG. 3 is an illustration displaying the positioning of the recordable media elements and the unrecorded control elements as show through the user viewable screen as the combined media stream.

FIG. 4 is an illustration displaying the static text boxes, dynamic text boxes, and controlling icon and their relative positioning through the user viewable screen as the combined media stream.

FIG. 5 is a block diagram displaying the general processes essential to the function of the present invention.

### DETAIL DESCRIPTIONS OF THE INVENTION

All illustrations of the drawings are for the purpose of describing selected versions of the present invention and are not intended to limit the scope of the present invention.

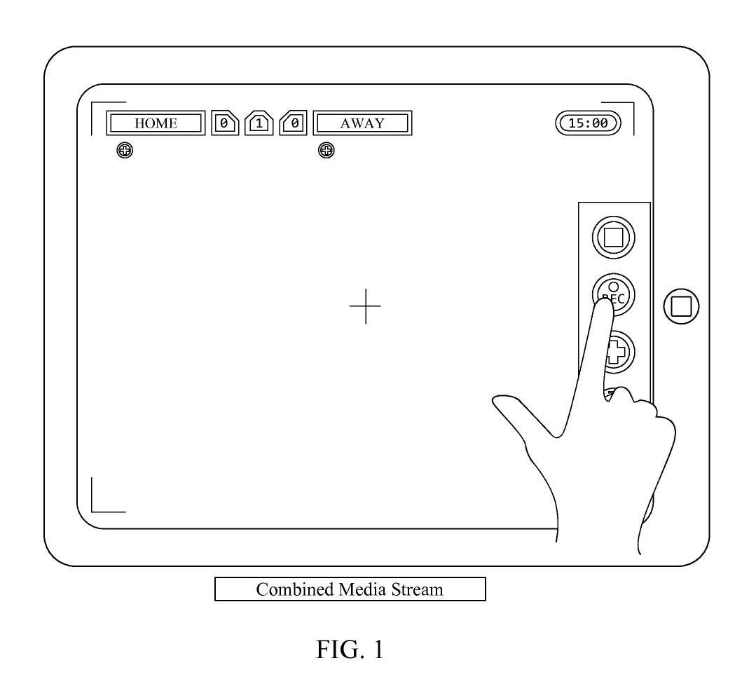

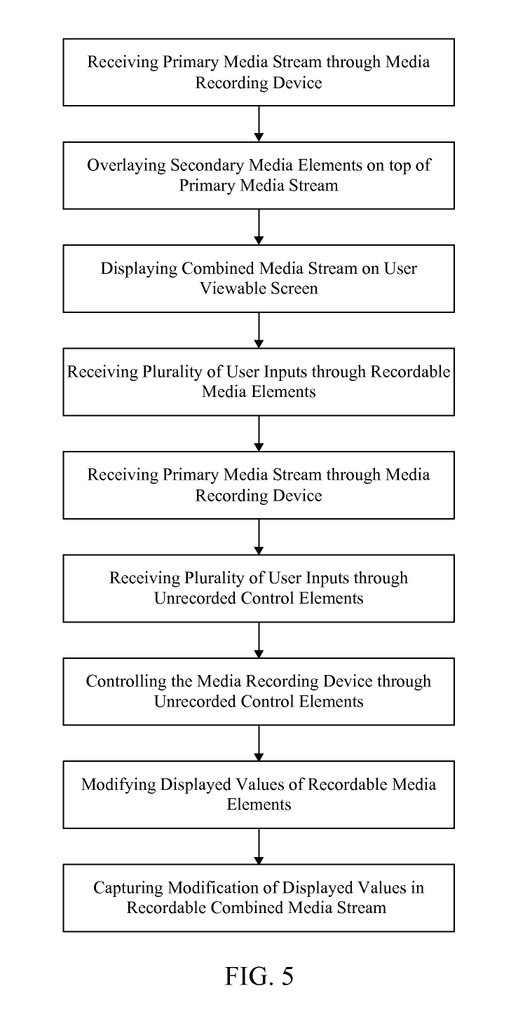

Referencing FIG. 1 and FIG. 5, the method of recording a media stream with interactive elements provides a user with a means of enhancing a media stream recording to include additional media elements relating to the events of the media stream. The present invention accomplishes this through executable instructions that receive a primary media stream through the media recording device, overlaying secondary media elements on top of the primary media stream, receiving a plurality of user inputs that modify the. The secondary media elements and the primary media stream are displayed on a user viewable screen of a media recording device as a combined media stream. During the recording process, the combined media stream enables a user to interact with the secondary media elements while simultaneously viewing the primary media stream. The secondary media elements seen on the combined media stream comprise recordable media elements and unrecorded control elements. During the recording process, the present invention captures a recordable combined media stream comprising the recordable media elements and the primary media stream. The plurality of user inputs received through the recordable media elements and the unrecorded control elements modify aspects of the recordable media elements and are recorded concurrently with the primary media stream.

Referencing FIG. 1, the method of recording a media stream with interactive elements is provided with a media recording device. The media recording device is an electronic device with hardware and software elements that operate cooperatively to record a media stream in a storage memory. In the current embodiment of the present invention, the media recording device comprises a user viewable screen. The user viewable screen is provided in order to enable a user to observe the capture of a primary media stream as well as the secondary media elements. In the current embodiment of the present invention, the user viewable screen is provided as a touch screen interface. A plurality of user inputs are received through the touch screen interface. The plurality of user inputs are detected corresponding to information displayed on the touch screen interface. Resultantly, the plurality of user inputs received are associated with secondary media elements such as the unrecorded control elements or the recordable media elements. In the preferred embodiment of the present invention, the plurality of user input are detected as gesture inputs. The gesture inputs detected through the touch screen interface may provide the secondary media elements with additional functions or outputs as each gesture input received through a secondary media element may be viewed as distinct based on a general motion or arrangement.

Referencing FIG. 5, the method of recording a media stream with interactive elements comprises the steps of receiving a primary media stream through the media recording device, overlaying secondary media elements on top of the primary media stream, displaying a combined media stream on the user viewable screen, receiving a plurality of user inputs through recordable media elements and unrecorded control elements, controlling the operations of the media recording device, modifying displayed values of the recordable media elements, and capturing a recordable combined media stream.

The method of recording a media stream with interactive elements receives a primary media stream through the media recording device. The primary media stream is a stream of data comprising audio and visual information recordable in a digital format and displayable through the user viewable screen. The primary media stream is utilized to form a combined media stream that is displayed through the user viewable screen of the media recording device. The secondary media elements may be selected based on the content of the primary media stream.

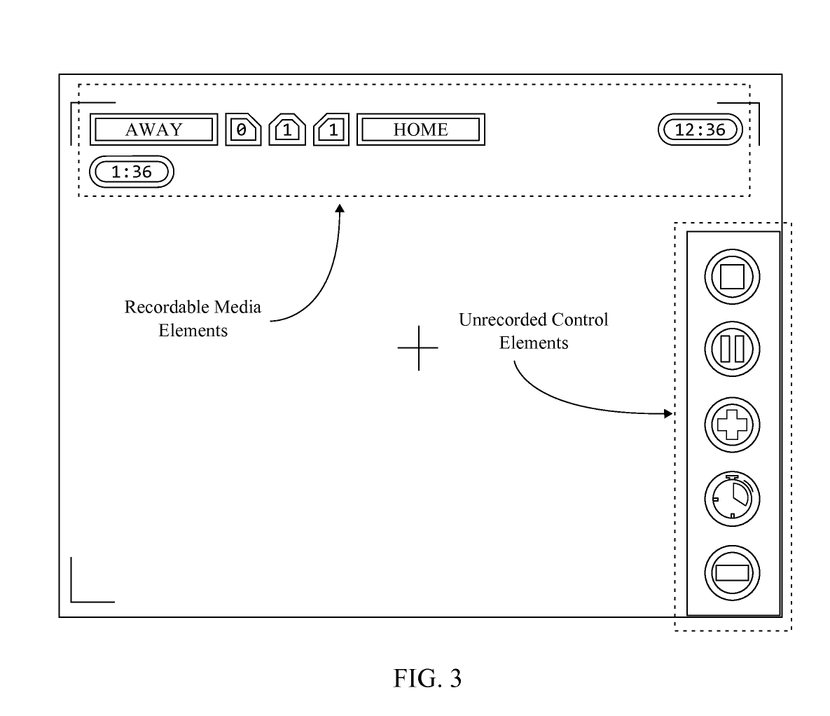

Referencing FIG. 1, FIG. 3, and FIG. 5, the method of recording a media stream with interactive elements overlays secondary media elements on top of the primary media stream. The secondary media elements are interactive visual components that receive particular user inputs to modify values of the secondary media elements as well as control operations of the media recording device. The secondary media elements comprise recordable media elements and unrecorded control elements. Both the recordable media elements and the unrecorded control elements are overlaid on top of the primary media stream and displayed on the user viewable screen as a combined media stream. Due to the variability of the content of the primary media stream, the present invention is provided with a plurality of secondary media elements. Each secondary media element of the plurality of secondary media elements comprises particularly configured recordable media elements and unrecorded control elements, whose configuration may include content and relative positioning to the primary media stream. The particularity of each secondary media element permits a user to select particular secondary media elements deemed most appropriate based on personal preference and/or relative to the content of the primary media stream. In the current embodiment of the present invention, the method receives a user input that selects particular secondary media elements from a plurality of secondary media elements. The plurality of secondary media elements are made available to the user through various means that include but are not limited to the user viewable screen. Upon receiving a selecting user input, the particular secondary media elements are overlaid on top of the primary media stream forming the combined media stream. The combined media stream is displayed through the user viewable screen. The user viewable screen displays the particular recordable media elements and the particular unrecorded control elements partially obscuring the primary media stream as per their particular positioning relative to the primary media stream.

Referencing FIG. 1 and FIG. 5, the method of recording a media stream with interactive elements comprises the step of receiving a plurality of user inputs through the recordable media elements. The recordable media elements receive user inputs that modify displayed values of the recordable media elements. Although, the particular displayed values of the recordable media elements vary depending on the particular secondary media elements selected, the displayed values may include but are not limited to integers, characters, and images. In the current embodiment of the present invention, the recordable media elements comprise static text boxes and dynamic text boxes. The displayed values of the static text boxes are modifiable though particular user inputs. The displayed values of the static text boxes remain constant unless a particular user input is received modifying said displayed value. The displayed values of the dynamic text boxes are initially modifiable through particular user inputs similar to the static text boxes. Unlike the static text boxes, the displayed values of the dynamic text boxes do not remain constant after receiving particular user inputs. The dynamic text boxes are used to display time dependent information where the initial displayed value may continuously change after receiving a particular user input and be halted after receiving another user input.

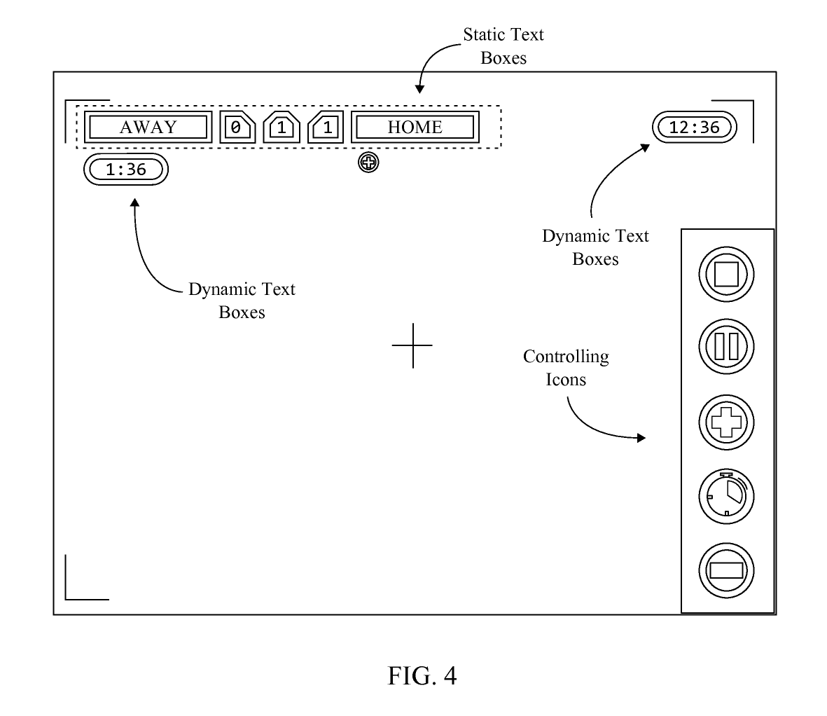

Referencing FIG. 4 and FIG. 5, the method of recording a media stream with interactive elements provides the recordable media elements as static text boxes comprising a first team score box and a second team score box. The first team score box and the second team score box are provided as a static text boxes used to log values associated with scoring events or actions observed in the primary media stream. The first team score box and the second team score box are well suited for keeping track of score during sporting event. The displayed values of the first team score box and the second team score box are provided as score values. A score value is the particular value award to a particular team following a scoring event or action observed in the primary media stream. A score value may be added or subtracted from the first team score box upon receiving a particular user input. It should be noted that the particular user input for adding a score value is different from the particular user input for subtracting a score value, as the subtraction of the score value could be understood as a correction. The modification to the displayed value of the first team score box and the second team score box are captured as part of the

Referencing FIG. 4, the method of recording a media stream with interactive elements provides the recordable media elements as static text boxes comprising team identification boxes. The team identification boxes are utilized as a means of identifying the team score boxes. The team identification boxes are positioned adjacent to their associated team score boxes wherein the first team identification box is positioned adjacent to the first team score box while the second team identification box is positioned adjacent to the second team score box. The displayed values of the team identification box are team identifiers. Team identifiers can be provided a textual information or pictorgraphical information that is specific to the particular team identification box.

Referencing FIG. 3 and FIG. 4, the modification of the displayed values of the team's identifications boxes is provided through the use of an unrecorded control element. Unrecorded control elements are displayed in the user viewable screen as part of the combined media stream. Unlike recordable control elements, the unrecorded control elements, as well as any interactions and modifications to their appearance are completely omitted in the recordable combined media stream. In order to modify the team identification boxes, an unrecorded control element is displayed upon receiving a particular user interaction. The displayed unrecorded control element as a team identification options menu. The team identification options menu contains a plurality of team identification options. A new team identifier is then displayed in a team identification box after at least one user input is received through the team identification options menu. It should be noted that the plurality of team identification options may include previously generated team identifiers and means to create new team identifiers. Unlike the previously generated team identifiers, the means to create new team identifiers may require separate user inputs following the particular user input for selecting the means to create a new team identification option. The aforementioned situation occurs when a textual input means is required in addition the selection of a team identification option.

The method of recording a media stream with interactive elements provides recordable media elements as dynamic text boxes comprising a game clock. Dynamic text boxes display values that change continuously upon receiving a particular user input. The initiation and cessation of the continuous changed in the displayed information of a dynamic text boxes is controlled through particular user inputs. Initial values of the displayed values are modifiable through various means. The game clock is a time dependent media element that displays a game time value. the game time value has an initial value, that upon receiving a particular user input continuously increases or decreases in value until either another particular user input is received or until a particular final value is reached. In many cases, the particular final value is a zero value but can be modified to be a particularly defined numerical value which may also halt the game clock.

The method of recording a media stream with interactive elements provides unrecorded control elements as controlling icons. The controlling icons comprise a game clock icon. The game clock icon is particular controlling icon that is used to control initiation and cessation of the game clock. The game clock icon receives are first user input that initiates the game clock. The initiation of the game clock commences a continuous change in the initial game time value. Upon receiving a first user input, a continuous change in the initial game time value may increase the game time value or decrease the game time value as a function of time. Following the initiation of the game clock, the game clock icon may change in appearance to signify to user that the game clock is running. The game clock is halted upon receiving a second user input through the game clock icon. The second user input can be the same as the first user input. Upon receiving the second user input through the game clock icon, the continuous change in the game time value is halted and can be initiated again upon receiving another user input. The method of recording a media stream with interactive elements actively records the changes and modifications to the dynamic text boxes as part of the recordable combined media stream. It should be noted that more than one game clock may be provided in the recordable combined media stream, as the game clock could be used to keep track of time dependent events occurring in the primary media stream. Such time dependent events include keeping track of the game time for periods or quarters of a game but can additionally be used to keep track of information for time outs and penalties.

The method of recording a media stream with interactive elements provides the unrecorded control elements as a game time options menu comprising a plurality of game start time options. The game time options menu is provided as the means of selecting or modifying the initial game time value to be displayed in the game clock. The game time selection menu displays a plurality of game start time options that include predefined initial game time values and/or a means of inputting a particular initial game time value. The game time options menu is generated after receiving a particular user input. The generation of the game time options menu displays the plurality of game start time option on the user viewable screen. The particular user input can be received through the game clock or through alternative means such as dedicated input generating settings or options. Upon receiving a particular user input for a particular game start time option, an initial game start time value is displayed within the game clock.

The method of recording a media stream with interactive elements enables modification of the game time value by receiving particular user input through either the game clock or controlling icons as well as a combination of both. The game time value displayed in the game clock can be modified increasing or decreasing current displayed game time value. The modification of the game time value is provided through particular user inputs received by either the game clock, controlling icons, or a combination of both. In the embodiment of the invention where the user viewable screen is a touch screen, the game clock could receive particular gestures inputs corresponding to different values for increasing or decreasing the game time value. In an embodiment of the invention the controlling icons may be provided with dedicated input means for increasing or decreasing values for the game time value. The utilization of both the game clock and the controlling icon to modify the game time value can be cooperatively utilized to facilitate the modification of the game time value, as the differentiation could provide different associated values by which the game time value may be modified.

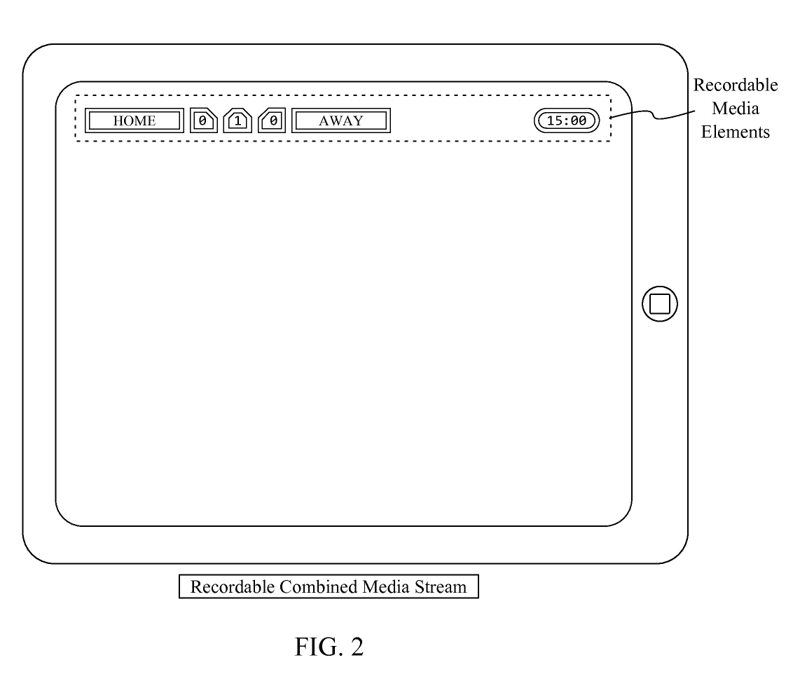

Referencing FIG. 2 and FIG. 5, the method of recording a media stream with interactive elements provides unrecorded control elements as controlling icon comprising a record icon, a pause icon, and a stop icon. The unrecorded control elements can control the operations of the media recording device including the initiation and cessation of the recordable combined media stream. The controlling icons are provided with a translucent box which they are positioned within. The controlling icons are provided with the translucent box in order to differentiate the controlling icons from elements of the primary media stream when displayed through the user viewable screen. The record icon is provided as the particular controlling icon that receives a user input that initiates the capture of the recordable combined media stream. The pause icon is provided as the particular controlling icon that halts the capture of the recordable combined media stream. The function of the pause icon and the record icon are dependent on the capture status of the recordable combined media stream, wherein the record icon can only initiate capture of the recordable combined media stream, if a recordable combined media stream is not being capture and the pause icon can only halt the capture of the recordable combined media stream if the recordable combined media stream is being captured. The dependencies in operation allow the pause icon to be positioned in the same place as the record icon. Capture initiation of the recordable combined media stream commences actions that create a tempfile for storing the audio and visual data associated with the recordable combined media stream. The tempfile can be stored either on directly on the media recording device or to a remote storage location provided no lose in functionality to the present invention. The stop icon receives a user input that terminates the capture of the recordable combined media stream. Termination of the recordable combined media stream, initiates steps that close the tempfile containing the audio and visual data prior to converting it into a user viewable file.

The method of recording a media stream with interactive elements provides recordable media elements as static text boxes comprising the first team identification box, the first team score box, the second team identification box, the second team score box, and a game period box. The static text boxes are provided with positional relationship displayed in the combined media stream and the recordable combined media stream relative to one another that can be influenced by changes to the particular values displayed in a static text box. The team identification boxes for the first team score box and the second score box are particular related to one another. The first team score box is found adjacent to the first team identification box, while the second team score box is found adjacent to the second team identification box. The game period box is a static text box that is used to differentiate the particular game period or game interval of in a primary media stream. During period changes, teams can switch field positioning that would make the previous positioning of the team identification boxes and team score boxes confusing. Through interrelating functions of the existing recordable media elements and unrecorded control elements, adding a period value to the game period box can be adapted to switch the positioning of the first team identification box and the first team score box with the second team identification box and the second team score box. The aforementioned particular change could be initiated upon the receiving a user input through the game clock signaling the initiation of the particular period.

It should be noted that the present invention may be implemented as either a hardware or software application associated with the media recording device. The present invention may be an executable set of instructions remotely or locally implemented enabling the aforementioned functions of the present invention.

In an embodiment of the invention, the method of recording a media stream with interactive elements requires the media recording device to receive a primary media stream. The primary media stream is any media stream recordable by the media recording device. Preferably, the primary media stream is an event or situation that benefits from maintaining an active record of the actions occurring during said event or situation. Due to the interactive nature of the secondary media elements, the present invention lends itself well to recording sporting event. Primary media streams derived from sporting event greatly benefit from the modification and manipulation of the recordable media elements, as the recordable media elements can be used to individual team scores, game time, and a plurality of game specific interactions.

In an embodiment of the invention, the secondary media elements are overlaid on top of the primary media stream creating a combined media stream. The secondary media elements are interactive feature of the combined media stream, modifiable through a plurality of user interactions. The combined media stream is a user viewable media stream showing the secondary media elements overlaid on top of the primary media stream. The secondary media elements are particularly positioned on top of the primary media stream in a manner that minimally obstructs viewing of the primary media stream. The secondary media elements are positioned on the periphery of the combined media stream.

In an embodiment of the invention, the combined media stream is displayed through the user viewable screen of the media recording device. The user viewable screen displays the combined media stream to a user. The user viewable screen shows a user the positioning of the secondary media elements overlaid on top of the primary media stream. The user viewable screen shows a user the recordable media elements and the unrecorded control elements of the secondary media elements. The recordable media elements of the secondary media elements are the features of the secondary media elements that are observable in the recordable combined media stream. In the embodiment of the invention, the recordable media elements display information relating to the identification of participants in the primary media event, recording occurrence of particular actions witnessed during the primary media event, and displaying time information specific to the primary media even. The unrecorded control elements of the secondary media elements are interactive features that manipulate or modify aspects of the recordable combined media stream but are not shown in the recordable combined media stream. In the embodiment of the invention, the unrecorded control elements are user interaction points that modify or manipulate information shown on the recordable media elements and control operations of the media recording device, such as the recording of the recordable combined media stream.

The secondary media elements receive a plurality of user inputs. The secondary media elements comprise the recordable media elements and the unrecorded control elements. Both the recordable media elements and the unrecorded control elements receive a plurality of user inputs that modify or manipulate aspects of the recordable media elements. The unrecorded control elements receive a plurality of inputs that modify or manipulate the aspects of the recordable media elements as well as control operation of the media recording device. In the embodiment of the invention, the user viewable screen is a touch screen interface. The recordable media elements and the unrecorded control elements receive a plurality of user inputs through the touch screen interface as direct inputs or as gesture inputs. Direct inputs are individual user inputs whose interaction points on the touch screen interface corresponds to viewable positioning of the recordable media elements and unrecorded control elements. Gesture inputs are user interactions that combine an individual user input and a secondary action or motion from a particular interaction point corresponding with to the touch screen interface.

The recordable media elements and the primary media stream are recorded by the present invention as a recordable combined media stream. The recordable combined media stream is the captured product of the combined media stream that omits the unrecorded control elements. The recordable combined media stream is stored as a user viewable media file.

In an embodiment of the invention, the method of recording a media stream with interactive elements can receive a plurality of user inputs through the unrecorded control elements to dictate operational actions of the media recording device. The unrecorded control elements receive a plurality of user inputs that initiate, pause, and end the recording of the recordable combined media stream. In order to accomplish this action, the unrecorded control elements comprise controlling icons positioned within a translucent box. The translucent box is a visual feature provided as a means of differentiating the controlling icons from elements of the primary media stream. The controlling icons positioned within the translucent box are shown through the user viewable screen and further comprise a record icon, a pause icon, and a stop icon. The record icon and the pause icon are viewable in a converse binary state relation, the record icon is only viewable when the media recording device is not recording, while the pause icon is viewable only when the media recording device is recording. The record icon receives a user input that initiates the recording of the recordable combined media stream. After initiating the recording of the combined media stream, the record icon is replaced by the pause icon. The pause icon receives a user input halts the recording of the recordable combined media stream temporarily. After pausing the recording of the combined media stream, the pause icon is replaced by the record icon. The stop icon receives a user input and ends the recording of the recordable combined media stream. Upon receiving the user input through the stop icon, the present invention displays an end recording notification on the user viewable screen. The end recording notification is provided as means of alerting the user to the progress of the media recording. it should be noted that the plurality of user input received through the controlling icons are provided as direct inputs, but it should be noted that in an additional embodiment of the present invention, the plurality of user inputs could be gesture inputs.

In an embodiment of the invention, the method of recording a media stream with interactive elements can receive a plurality of user inputs through the recordable media elements that facilitating the tracking of scores when the primary media stream is a team based sporting event. The recordable media elements would comprise static text boxes. The static text boxes facilitate the tracking of scores when the primary media stream is a team based sporting event by assigning a score box to each participant team and modifying a score value throughout the progress of the sporting event. The static text boxes comprise at least two team identification boxes and a least two team score boxes. Each team identification box displays a means of identifying a particular participating team. Each team identification box corresponds to a particular team score box. The at least two team identification boxes and the at least two team score boxes receive a plurality of user inputs that add a score value or subtract a score value.

In an embodiment of the invention, a score value is added to a first teams score box upon receiving a user input through the first team identification box. Similarly, a score value is added to a second teams score box upon receiving a user inputs through the second teams identification box. Due to the inevitability of an incorrect user input, score values can be subtracted from either the first team score box or the second team score box by receiving a user input through either. A score value is subtracted from the first team score box upon receiving a user input through the first team score box. Similarly, a score value is subtracted from the second team score box upon receiving a user input through the second team score box. As a means of enhancing addition of a score value in the recordable combined media stream, a score animation is displayed upon adding the score value to either the first team score box of the second team score box. It should be noted that the plurality of user input received through the static text boxes to facilitate score tracking are provided as direct inputs, but it should be noted that in an additional embodiment of the present invention, the plurality of user inputs could be gesture inputs.

The method of recording a media stream with interactive elements receives a plurality of user inputs through recordable media elements and non-recordable media elements that facilitate the modification of time dependent recordable media elements related to a primary media stream. Team based sporting events contain timed periods or intervals of play and in order to display this information, the displayable media element comprises a dynamic text box that functions as a game clock.

In an embodiment of the invention, the initial time displayed within the dynamic text box is modified by receiving a plurality of user inputs through the unrecorded control elements and the recordable media elements. The dynamic text box is a game clock that displays a game timer particularly modified to correspond with the particulars of the sporting event being received as the primary media stream. The game clock receives a plurality of user inputs that modify the value of the game timer. The unrecorded control elements are controlling icons positioned within a translucent box comprising a game clock icon, a plus sign icon, and a minus sign icon. The game clock icon receives a plurality of user inputs that control the activation and deactivation of the recordable media elements. The plus sign icon adds a specific amount of time to the game timer. The minus sign icon subtracts a specific amount of time from the game timer. The game timer has a particular game start time. The game start time is modified through a gesture interaction with the game clock. A plurality of game start time options are generated on the user viewable screen following a long hold input through the game clock. The long hold input is a gesture input. A particular game start time is selected and displayed in game clock upon receiving a user input through a particular game start time option of the plurality of game start time options. The game timer initiates the countdown from the game start time upon after a first user input is received through the game clock icon. The countdown of the game timer is halted after a second user input is received through the game clock icon. A particular amount of time is added or subtracted to the game clock upon receiving a gesture input through the game clock. The game clock receives a directional swipes related to the addition or subtraction of time from the game timer. The directional swipes are user inputs is entered at a particular interaction point and then moved in a particular direction recognizable by the present invention. In the embodiment of the invention, a particular amount of time is added to the game timer upon receiving a first directional swipe through the game clock, wherein the first directional swipe is a swipe in a first direction. Similarly, a particular amount of time is subtracted from the game timer upon receiving a second directional swipe through the game clock, wherein the second directional swipe is a swipe in a second direction. Modification to the time value in a game timer is facilitated by providing two different amounts of time to modify the game timer. The two different amounts of time are differentiated as being a particular amount of time and a specific amount of time. In the preferred embodiment of the present invention, the particular amount of time is a greater value to the specific amount of time. A specific amount of time is added or subtracted from the game timer through receiving user inputs through the controlling icons. A specific amount of time is added to the game timer upon receiving a user input through the plus sign icon. Similarly, a specific amount of time is subtracted from the game timer upon receiving a user input through the minus sign icon.

The method of recording a media stream with interactive elements receives a plurality of user inputs through recordable media elements and non-recordable media elements that facilitates modification of a specific time dependent recordable media elements related to a primary media stream. Team based sporting events contain timed periods or intervals of play or modify aspects of the sporting event upon the conclusion of or initiation of another interval of play. An example of which occur following the conclusion of a period or interval of play, where opposing teams alternate their original position. Additionally team based sporting events may require addition dynamic text boxes to utilized to differentiate a particular time event for a particular team. The aforementioned instance relates generally to penalties or time outs where a time specific game clock is required in addition to the normal game clock.

In an embodiment of the invention, the recordable media elements are static text boxes and dynamic text boxes. The static text boxes comprise a first team identification box, a first team score box, a second team identification box, a second team score box, and a game period box. The dynamic text boxes comprise a game clock, a first team clock, and a second team clock. The first team identification box and the second team identification boxes each identify particular participating teams. The first team score box and the second team score box identify a score value held by each particular team. The game period box is identifies the particular period of play. The game clock displays a game timer specifically modified to relate to the particular period or interval of play. The first team clock and the second team clock are team specific game timers for displaying penalty and time out information. The unrecorded control elements utilized to modify the recordable media elements comprise a controlling icon positioned within a translucent box and controlling icons positioned adjacent to the static text boxes. The controlling icon positioned within the translucent box is the game clock icon. The game clock icon controls the initiation and pausing of the all game clocks. The controlling icons positioned adjacent to the static text boxes are a first clock modifier and a second clock modifier. The first clock modifier and the second clock modifier generate the first team clock and the second team clock, respectively, upon receiving a user input. The first clock modifier and the second clock modifier are positioned adjacent to the first team identification box and the second team identification box, in order to facilitate generation of the particular team clock. A game period value is increased upon receiving a user input through the game period box. Occasionally, team positions change on a playing field following the changing of a period or interval of play, generally the switch occurs at a particular period value. The embodiment of the invention accommodates this by switching the positioning of the first team identification and the first team score box with the positioning of the second team identification box and the second team score box after detecting a particular period value following the user input through the gamer period. A period value animation is displayed when a first user input is received through the game clock icon immediately following the accession of a period value to the game period box. The first team clock and the second team clock are displayed upon receiving a user input through the first clock modifier and the second clock modifier respectively. The first team clock and the second team clock are each display a particular team timer, where the first team clock displays a first team timer, and the second team clock displays a second team timer. The first team timer and the second team timer are each dependent on the game timer and subsequently rely on user input through the game clock icon to initiate and pause the countdown. The first team timer and the game timer simultaneously initiate their countdown after a first user input is received through the game clock icon. Similarly, the second team timer and the game timer simultaneously initiate their countdown after the first user input is received through the game clock icon. Conversely the first team timer and the game timer pause their countdown simultaneous after a second user input is received through the game clock icon. The second team timer and the game timer pause their countdown simultaneously after a second user input is received through the game clock icon. It should be noted that the game timer values for the first team clock and the second team clock are modified in a similar manner to the game clock, wherein he game clock uses the both gesture and direct inputs to select, differentiate, and modify game start times.

In an embodiment of the invention, the method of recording a media stream with interactive elements receives a plurality of user inputs through recordable media elements and unrecorded control elements that assist in the identification of particular participating teams. Due to the many types of sporting events and the plurality of different leagues, the name of a particular participating team would be difficult to predict and include in an easily accessible list. The differentiation of the participating teams is facilitated by including a non displayable control element that enables modification of the identification of a participating team. The recordable media elements are provided with static text boxes comprising the team identification boxes. The plurality of team identification options are unrecorded control elements that comprise at least two predefined team name options, a new team name creation option, and a profile selection option. The at least two predefined team name options are correspond are default differentiators that identify a team based on being a home team or an away team. a predefined team name is displayed in the team identification box upon receiving a user input identifying one of the predefined team name options of the at least two predefined team name options. A new team creation screen is displayed upon receiving a user input through the new team creation option. The new team creation screen contains input fields and an input method, such as a keyboard for entering a plurality of new team values. After the plurality of new team values have been received, a new team name value is displayed in the team identification box only after receiving a user confirmation input through the new team creation screen. A profile login screen is displayed upon receiving a user input through the profile selection option. The profile login screen requires a network connected device and an established account in order to retrieve previously created team name options from a cloud based storage location.

Although the invention has been explained in relation to its preferred embodiment, it is to be understood that many other possible modifications and variations can be made without departing from the spirit and scope of the invention as hereinafter claimed.

What is claimed is:

1. A method of recording a media stream with interactive elements comprises the steps of:
providing a media recording device comprising a user viewable screen;
receiving a primary media stream through the media recording device;
overlaying secondary media elements on top of the primary media stream, wherein the secondary media element comprise recordable media elements and unrecorded control elements.
displaying the combined media stream on the user viewable screen, wherein the combined media stream comprises the secondary media elements and the primary media stream;
receiving a plurality of user inputs through the recordable media elements;
receiving a plurality of user inputs through the unrecorded control elements;
controlling the media recording device through the unrecorded control elements;
modifying displayed values of the recordable media elements; and
capturing modification of the displayed values in a recordable combined media stream, wherein the recordable combined media stream comprises the primary media stream and the recordable media elements.

2. The method of recording a media stream with interactive elements as claimed in claim 1 comprises the step of:
providing the user viewable screen as a touch screen interface; and
detecting the plurality of user input through the touch screen interface.

3. The method of recording a media stream with interactive elements as claimed in claim 2, wherein the plurality of user inputs are gesture inputs.

4. The method of recording a media stream with interactive elements as claimed in claim 1 comprises:
receiving a user input selecting particular secondary media elements from a plurality of secondary media elements;
overlaying the particular secondary media elements on top of the primary media stream; and
displaying the primary media stream being partially obscured by the particular secondary media elements through the user viewable screen.

5. The method of recording a media stream with interactive elements as claimed in claim 1 comprises:
providing the recordable media elements as static text boxes, wherein the static text boxes comprise a first team score box and a second team score box;
providing the displayed values of the static text boxes as score values;
adding a score value to either the first team score box or the second team score box upon receiving a particular user input; and
subtracting a score value to either the first team score box or the second team score box upon receiving another particular user input.

6. The method of recording a media stream with interactive elements as claimed in claim 1 comprises:
providing the recordable media elements as static text boxes, wherein the static text boxes comprises a team identification box;
providing unrecorded control elements as a team identification options menu, wherein the team identification options menu comprises a plurality of team identification options;
providing the displayed value of the static text box as a team identifier;
displaying the plurality of team identification options upon receiving a particular user input generating the team identification options menu; and
displaying a new team identifier in the team identification box upon receiving at least one user input through the team identification options menu.

7. The method of recording a media stream with interactive elements as claimed in claim 1 comprises:
providing the recordable media elements as a dynamic text box, wherein the dynamic text box comprises a game clock;
providing the unrecorded control elements as controlling icons and a game time selection menu, wherein the controlling icon comprises a game clock icon and the game time options menu comprises a plurality of game start time options;
providing the displayed value of the dynamic text box as game time value;
displaying the plurality of game start time options upon receiving a user input generating the game time options menu;
displaying a particular initial game time value in the game clock upon receiving a user input selecting the particular game start time option;
initiating the game clock upon receiving a first user input through the game clock icon, wherein the initiation commences a continuous change in the game time value;
pausing the game clock upon receiving a second user input through the game clock icon, wherein the continuous change in the game time value is halted;
modifying the game time value by receiving a particular user input through the game clock, wherein modification of the game time by increase or decreases the game time value; and
modifying the game time value by receiving a particular user inputs through the controlling icons, wherein modification of the game time by increase or decreases the game time value.

8. The method of recording a media stream with interactive elements as claimed in claim 1 comprises:
providing the unrecorded control elements as controlling icons comprising a record icon, a pause icon, and a stop icon;
providing the controlling icons positioned within a translucent box;
initiating recording of a recordable combined media stream upon receiving a user input through a record icon of the controlling icons;
pausing recording of a recordable combined media stream upon receiving a user input through a pause icon of the controlling icons; and
ending recording of a recordable combined media stream and displaying end recording notification on the user viewable screen upon receiving a user input through a stop icon of the controlling icons.

9. The method of recording a media stream with interactive elements as claimed in claim 1 comprises:
providing the recordable media elements as static text boxes comprising a first team identification box, a first team score box, a second team identification box, a second team score box, and a game period box;
providing unrecorded control elements as controlling icons comprising a game clock icon;
adding a period value to the game period box upon receiving a user input through the game period box; and
switching positioning of the first team identification box and the first team score box with the second team identification box and the second team score box upon detecting a particular period value following a user input through the game period box.

10. A method of recording a media stream with interactive elements comprises the steps of:
providing a media recording device comprising a user viewable screen;
providing the user viewable screen as a touch screen interface;
receiving a primary media stream through the media recording device;
overlaying secondary media elements on top of the primary media stream, wherein the secondary media element comprise recordable media elements and unrecorded control elements.
displaying the combined media stream on the user viewable screen, wherein the combined media stream comprises the secondary media elements and the primary media stream;
detecting the plurality of user input through the touch screen interface;
receiving a plurality of user inputs through the recordable media elements;
receiving a user input selecting particular secondary media elements from a plurality of secondary media elements;
overlaying the particular secondary media elements on top of the primary media stream;
displaying the primary media stream being partially obscured by the particular secondary media elements through the user viewable screen;
receiving a plurality of user inputs through the unrecorded control elements;
controlling the media recording device through the unrecorded control elements;
modifying displayed values of the recordable media elements; and
capturing modification of the displayed values in a recordable combined media stream, wherein the recordable combined media stream comprises the primary media stream and the recordable media elements.

11. The method of recording a media stream with interactive elements as claimed in claim 10, wherein the plurality of user inputs are gesture inputs.

12. The method of recording a media stream with interactive elements as claimed in claim 10 comprises:
providing the recordable media elements as static text boxes, wherein the static text boxes comprise a first team score box and a second team score box;
providing the displayed values of the static text boxes as score values;
adding a score value to either the first team score box or the second team score box upon receiving a particular user input; and
subtracting a score value to either the first team score box or the second team score box upon receiving another particular user input.

13. The method of recording a media stream with interactive elements as claimed in claim 10 comprises:
providing the recordable media elements as static text boxes, wherein the static text boxes comprises a team identification box;
providing unrecorded control elements as a team identification options menu, wherein the team identification options menu comprises a plurality of team identification options;
providing the displayed value of the static text box as a team identifier;
displaying the plurality of team identification options upon receiving a particular user input generating the team identification options menu; and
displaying a new team identifier in the team identification box upon receiving at least one user input through the team identification options menu.

14. The method of recording a media stream with interactive elements as claimed in claim 10 comprises:
providing the recordable media elements as a dynamic text box, wherein the dynamic text box comprises a game clock;
providing the unrecorded control elements as controlling icons and a game time selection menu, wherein the controlling icon comprises a game clock icon and the game time options menu comprises a plurality of game start time options;
providing the displayed value of the dynamic text box as game time value;
displaying the plurality of game start time options upon receiving a user input generating the game time options menu;
displaying a particular initial game time value in the game clock upon receiving a user input selecting the particular game start time option;
initiating the game clock upon receiving a first user input through the game clock icon, wherein the initiation commences a continuous change in the game time value;
pausing the game clock upon receiving a second user input through the game clock icon, wherein the continuous change in the game time value is halted;
modifying the game time value by receiving a particular user input through the game clock, wherein modification of the game time by increase or decreases the game time value; and
modifying the game time value by receiving a particular user inputs through the controlling icons, wherein modification of the game time by increase or decreases the game time value.

15. The method of recording a media stream with interactive elements as claimed in claim 10 comprises:
providing the unrecorded control elements as controlling icons comprising a record icon, a pause icon, and a stop icon;
providing the controlling icons positioned within a translucent box;
initiating recording of a recordable combined media stream upon receiving a user input through a record icon of the controlling icons;
pausing recording of a recordable combined media stream upon receiving a user input through a pause icon of the controlling icons; and
ending recording of a recordable combined media stream and displaying end recording notification on the user viewable screen upon receiving a user input through a stop icon of the controlling icons.

16. The method of recording a media stream with interactive elements as claimed in claim 10 comprises:
providing the recordable media elements as static text boxes comprising a first team identification box, a first team score box, a second team identification box, a second team score box, and a game period box;
providing unrecorded control elements as controlling icons comprising a game clock icon;
adding a period value to the game period box upon receiving a user input through the game period box; and
switching positioning of the first team identification box and the first team score box with the second team identification box and the second team score box upon detecting a particular period value following a user input through the game period box.
